(19) United States
(12) Patent Application Publication
(10) Pub. No.: US 2002/0025189 A1
(43) Pub. Date: Feb. 28, 2002

(54) Device for manual replacement and transport of the roller of a copying machine or an electrophotographic printer

(76) Inventors: Andreas Konday, Deggingen (DE); Peter Schmidt, Geislingen (DE); Markus Weber, Aichwald (DE)

Correspondence Address: Lawrence P. Kessler, Patent Department, NexPress Solutions LLC, 1447 St. Paul Street, Rochester, NY, 14653-7103, US

(21) Appl. No.: 09/850,513

(22) Filed: May 7, 2001

(30) Foreign Application Priority Data
May 17, 2000 (DE) 100 23 715.0

(51) Int. Cl. G03G 15/16

(52) U.S. Cl. 399/122

(57) ABSTRACT

The invention relates to a device for manual replacement and transport of the roller (1) of a copying machine or an electrophotographic printer. To arrive at a device which makes it easier and safer to carry out customer service, especially replacement and transport of hot, heavy and large rollers, and moreover which has a simple, compact and economical structure, on the one hand there is a protective container (5) which can be preferably slipped over the roller (1) which has been released in the machine and its carrying means (T1; T2); and the roller (1) can be removed from the bearing points (L1; L2) of the machine with the protective container (5) slipped on using its carrying means (T1; T2) which project out of the protective container, and can be inserted into the bearing points; on the other hand, on its two axial ends the roller (1) has one carrying handle (T1; T2at a time as the carrying means, by which the roller can be guided into essentially slotted openings which run radially from the outside periphery to the center axis (Y1) of the bearing points and which are located on the bearing points (L1; L2) of the machine, can be radially inserted into the bearing points, and can be removed from them; moreover, there is a transport container (6) into which the protective container (5) provided with the roller (1) can be manually inserted and removed, in the transport container there being means (61; 62) for securing the protective container and the roller.

The invention relates to a device for manual replacement and transport of the roller of a copying machine or an electrophotographic printer.

Copying machines of the initially mentioned type are known in the form of copiers in which the roller is replaceable and transportable for service purposes. Here the roller can be equipped with carrying means, in which it can turn freely around its center axis. The copier for its part has rollers for routing through and delivering a toner image-bearing recording medium in the form of a sheet or strip, which rollers can be operated in rotation in an adjoining, axially parallel arrangement in the bearing points of the machine, and are supported by their axial ends, and on the other hand there are manually activated means for releasing the rollers in their bearing points and for separating the rollers in the radial direction for purposes of removing them from their bearing points and inserting them into their bearing points.

EP-0 000 631 B1 discloses a copier of the initially mentioned type. In it the fixing unit for toner image-bearing sheets of paper can be removed laterally from the copier for service purposes and has means in the form of a manually actuated swiveling lever system for release of the fixer/heating roller. The fixing/heating roller moreover for its replacement and carrying has carrying means in the form of a single U-shaped carrying handle which is located rigidly on a U-shaped holding frame spaced in the middle between the axial ends of the fixing/heating roller and radially to the center axis of the roller. The U-shaped holding frame on its free U-leg ends has one bearing each for one of the axial ends of the roller in which it can be freely turned. Moreover the holding frame on the outside on its free U-leg ends has cube-shaped, separate bearing blocks which are connected rigidly to the leg ends and by which the fixing/heating roller can be inserted into the U-shaped bearing points of the fixing unit and removed.

The defect of this disclosed embodiment is that when using large, heavy fixing/heating rollers, for purposes of improving fixing quality, it is difficult to replace and carry the fixing/heating roller without jamming and damaging by a single carrying handle, and when removing a hot fixing/heating roller and placing it in the transport container this cannot be done without endangering the service personnel and damaging the roller.

Therefore the object of the invention is to devise a device of the initially mentioned type which does not have these defects, but makes it safer and easier to carry out customer service of the machine, especially replacement and transport of hot, heavy and large rollers, and moreover has a simple, compact, economical structure.

The object is achieved as claimed in the invention with a device as claimed in claim 1 by there being a protective container which can be preferably slipped over a roller which has been released in the device and its carrying means. The roller can then be removed from the bearing points of the device for example with the protective container slipped on by its carrying means which project out of the protective container and can be placed again into the bearing points.

Advantageously the protective container has an essentially U-shaped cross sectional profile with an inside cavity for holding a roller which has a diameter which is larger than one outside diameter of the roller, such that in the protective container which has been slipped onto the carrying means of the roller there is no contact between the protective container and the roller; and the protective container has recesses in its container wall for holding the carrying means of the roller which has an inside width which compared to the assigned outside diameter of the carrying means is predetermined such that the protective container with its recesses can be placed on the carrying means by clamping.

Feasibly there is moreover a transport container in which the protective container provided with the roller can be manually inserted and removed, in the transport container there being means for securing the protective container and the roller.

The invention moreover relates to a copying machine or an electrophotographic printer as claimed in the invention with an replaceable roller which has on its two axial ends one carrying handle at a time as the carrying means, by which the roller can be guided into essentially slotted openings which run radially from the outside periphery to the center axis of the bearing points and which are located on the bearing points of the machine, can be radially inserted into the bearing points, and can be removed from them. This is because in this way it is possible to safely remove the roller from the copier without the danger of injury.

Advantageously, on the one hand the carrying handles are arranged centered to the axial center axis on the ends of the roller; and the carrying handles of the roller project axially beyond the bearing points of the device and beyond the protective container; on the other hand, at least one of the two carrying handles of the roller has means for axial and radial centering and guiding of the roller in its bearing points in the machine; and at least one of the two carrying handles of the roller (1) has means (11; 21) on the roller for axial and radial centering and guidance of a protective container (5) which many be present.

Other features and advantages can be taken from the description of the embodiments of the invention shown in the drawings and from the dependent claims.

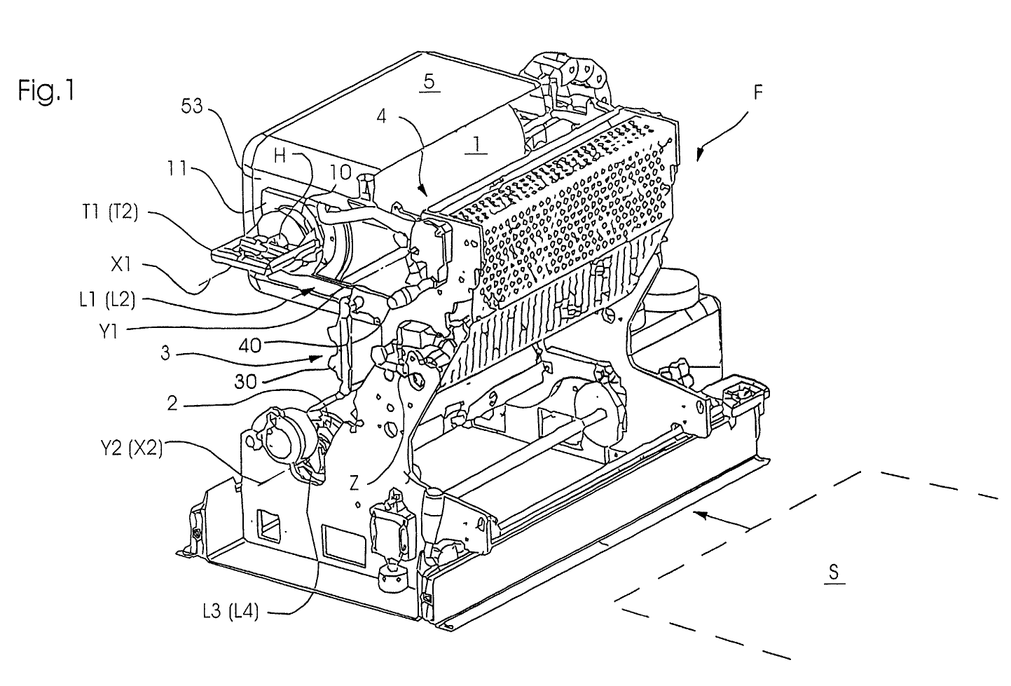

FIG. 1 shows the device as claimed in the invention as a protective and handling container on the fixing/heating roller of a fixing unit which has been opened and removed from a copying machine, in a three-dimensional representation,

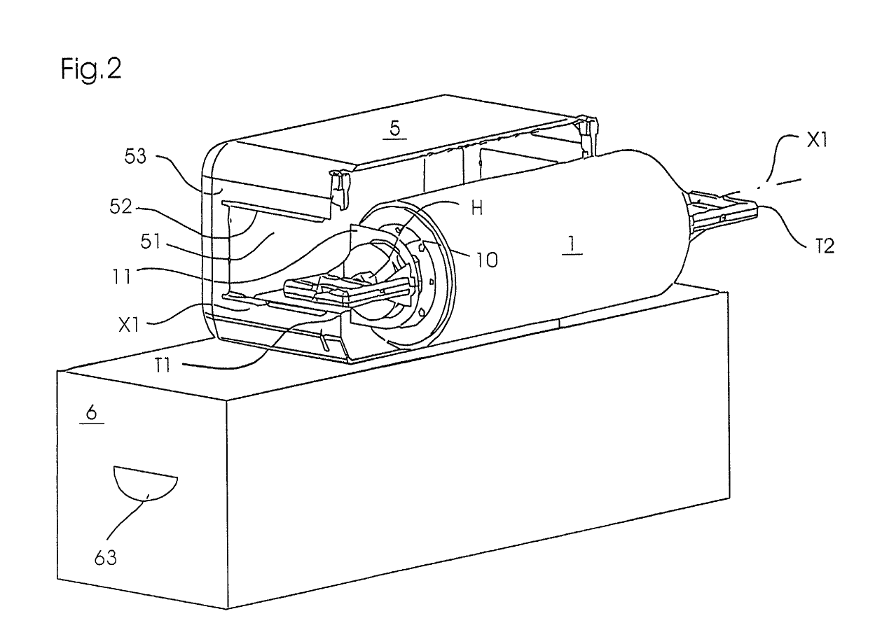

FIG. 2 shows the device as claimed in the invention from FIG. 1 with the fixing/heating roller pushed partially into the protective container and removed from the fixing unit in an enlarged three-dimensional view, above the transport container,

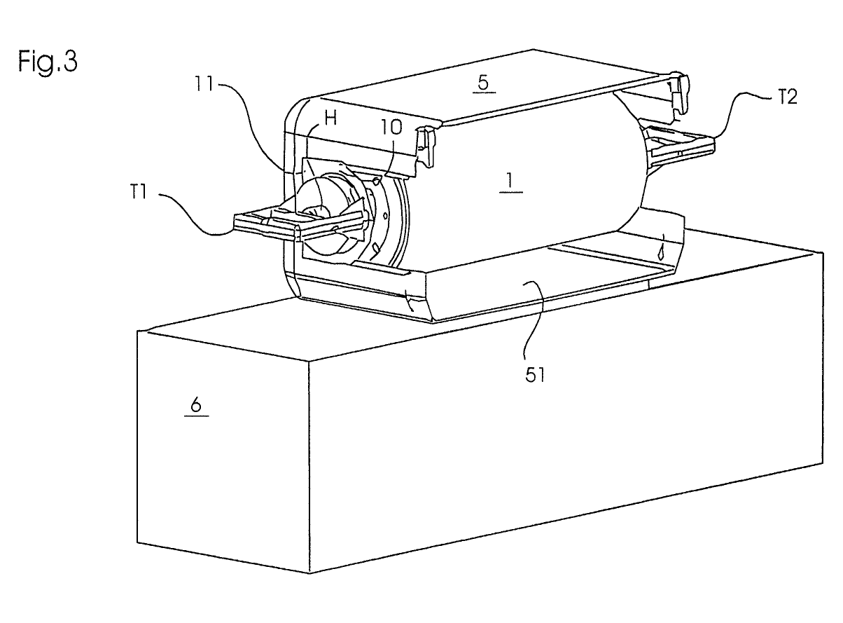

FIG. 3 shows the device as claimed in the invention from FIG. 2 with the fixing/heating roller inserted into the protective container above the transport container,

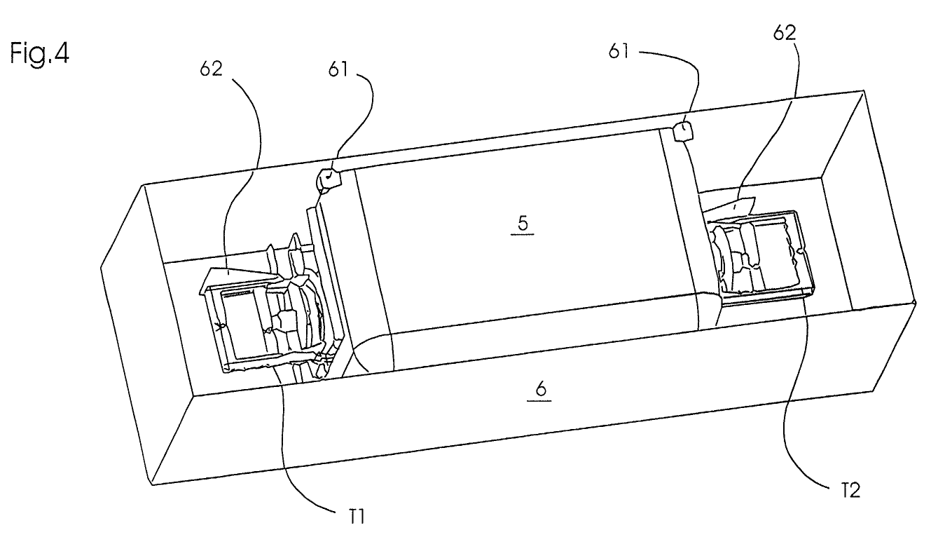

FIG. 4 shows the device as claimed in the invention from FIG. 3 with the protective container which contains a fixing/heating roller and which has been inserted into the transport container, in a three-dimensional view from the top.

The following description according to FIGS. 1 to 4 relates to one preferred embodiment of the device as claimed in the invention for manual replacement and transport of the roller of a copying machine.

The device here is located on the fixing/heating roller of a fixing unit F, the fixing unit being located in a copying machine of the conventional type which is not shown, for example a copier.

For one skilled in the art in this field it goes without saying that the inventive device can also be used in other machines, such as in printers, image transfer units, photoprinters with fixing units and sheet/strip conveyor units or in sheet sorters with sheet conveyor units and that the rollers can be made in the form of pressure, image transfer or sheet conveyor rollers.

The fixing unit F which is shown in FIG. 1 is shown in the position removed laterally from the copier on a carriage of the conventional type which is not shown and in an opened, upper position which is swiveled with its fixing roller 1 by means of its upper chassis part in around a swiveling axis Z.

The fixing unit F here has a fixing roller 1 in the upper part of the chassis and a pressure roller 2 in the lower part of the chassis in a roller pair arrangement for routing through and conveying a recording medium S in the form of a sheet or strip; the rollers are supported with their axial ends in bearing points L1; L2; L3; L4 of the chassis parts to be able to operate by rotation, in the closed position of the fixing unit in an adjoining, axially parallel arrangement.

To swivel the upper chassis part of the fixing unit or to separate the rollers 1;2 in the radial direction into the open position of the fixing unit, for purposes of removal of the fixing roller 1 from its bearing points L1; L2 and/or insertion into them, there are manually activated means 4 with a toggle lever unit with a handle and with an actuating lever 40.

The fixing roller 1 is equipped with carrying means T1; T2 which each have conventional pivot bearings which are not shown and in which the fixing roller is mounted to be able to turn freely around its center axis X1. Furthermore, the fixing roller 1 is equipped with a heating lamp H which is attached centered in it for purposes of its heating.

Furthermore, the fixing unit F at the bearing points L1; L2 in the upper part of the chassis has manually activated means 3 for releasing the fixing roller 1 in its bearing points for purposes of removing it from them and/or inserting it into its bearing points.

The roller 1, as shown in FIGS. 1 to 4, has on its two axial ends one carrying handle T1; T2 each as the carrying means, by which the roller can be guided into essentially slotted openings which run radially from the outside periphery to the center axis Y1 of the bearing points and which are located on the bearing points L1; L2 of the machine, it can be radially inserted into the bearing points and it can be removed from them.

Furthermore, there is a separate protective container 5 which can be slipped over the roller 1 or the fixing roller which has been released in the machine and its carrying means T1; T2; the roller 1 with the protective container 5 slipped on can be removed from the bearing points L1; L2 of the machine and/or inserted into them by means of its carrying means T1; T2 which project out of the protective container.

The protective container 5 has an essentially U-shaped cross sectional profile with an inside cavity 51 for holding the fixing roller 1 which has a diameter which is larger than the outside diameter of the roller such that with the protective container slipped onto the carrying means of the roller there is no contact between the protective container and its inside walls and the roller.

Furthermore the protective container 5, as shown in FIGS. 1 and 2, has recesses 52 in its wall 53 for holding the carrying means T1; T2 of the fixing roller 1 which has an inside width which compared to the assigned outside diameter of the carrying means is predetermined such that the protective container with its recesses can be placed on the carrying means by clamping.

The carrying handles T1; T2 of the carrying means are arranged centered here to the axial center axis X1 on the ends of the fixing roller 1; and the carrying handles of the roller project axially beyond the bearing points L1; L2 of the machine or the fixing unit F and beyond the protective container 5. The carrying handles T1; T2 are made here in the form of essentially square brackets or eyes.

In one alternative embodiment as claimed in the invention which is not shown, the carrying handles are made as round or oval handles, eyes or knobs.

The protective container 5 on its two ends or axially located side walls 53 has essentially slotted recesses 52 for holding the center/guiding/holding means 11 of the carrying handles T1; T2, which means are located on the axial ends of the roller 1. The inside width of the recesses 52 is matched relative to the assigned outside diameters of the center/guiding/holding means 11 such that the protective container 5 with its side walls 53 or recesses 52 can be clamped thereon.

Here the slotted recesses 52 for the means 11 on the side walls 53 of the protective container 5 are arranged centered to the axial center axis of the inside cavity 51 of the U-shaped protective container; and the recesses and the inside cavity 51 have identical radial alignments for slipping the protective container onto the fixing roller 1 and for removing it therefrom.

The protective container 5 moreover consists of a spring-elastic, thermally resistant and insulating plastic material.

As shown in FIGS. 1 to 3, on the one hand the two carrying handles T1; T2 of the fixing roller 1 have means 10 for axial and radial centering, guiding and holding of the roller 1 in its bearing points L1; L2 in the machine or in the fixing unit F; and on the other hand, they have means 11 for axial and radial centering, guiding and holding of the protective container 5 on the roller 1 or on the carrying means T1; T2.

The means 10; 11 for axial and radial centering, guiding and holding of the fixing roller 1 in the bearing points L1; L2 of the fixing unit F and in the recesses 52 of the protective container 5 combined and made integral are located on the carrying handles T1; T2.

The means 10; 11 are made in the form of annular disks which are located concentrically around the center axis X1 of the fixing roller 1, one disk as a time being located in the area of each axial end of the roller 1 and spaced away from it.

The two means 10 for centering, guiding and holding of the fixing roller 1 in the bearing points L1; L2 are made as essentially round annular disks which when the fixing roller is inserted into the bearing points L1; L2 are each inserted into one groove (not shown) of the bearing points which runs annularly. The carrying handles T1; T2 are inserted into radially running slotted recesses or openings of the bearing points so that they are secured against twisting and only the fixing roller 1 can turn freely in its pivot bearings which are contained in the carrying means L1; L2, for example, in conventional ball bearings.

The two means 11 for centering, guiding and holding of the protective container 5 are located as a rectangular area on the annular disks, which area runs radially to the outside, away from the bearing points L1; L2 and lengthwise along the slotted guides of the bearing points, so that after releasing the fixing roller 1 in its bearing points L1; L2 by an unlocking/locking lever 30 of the means 3, the protective container 5 can be slipped by means of its grooves in the recesses 52 of the side walls 53 onto this rectangular area 11 of the two annular disks of the carrying means T1; T2.

To transport the fixing roller 1, as shown in FIGS. 2 to 4; there is a transport container 6 with two handles 63 on the side walls, in which the protective container 5 which is provided with the fixing roller can be manually inserted and removed, the transport container containing means 61; 62 for securing the protective container and the roller.

As shown in FIG. 4, the means 62 located on the bottom of the transport container for securing the fixing roller 1 engage the carrying handles T1; T2 of the roller and act against the securing means 61 of the protective container 5, which means is located on the lengthwise wall of the transport container. The means 61; 62 for securing the roller and the protective container are made spring-elastic, the means 62 being made in the form of a spring clip and the means 61 being made in the form of retaining pins on which the eyes of the protective container 5 can be slipped.

In an alternative embodiment which is not shown, the transport container 6 has several securing means 61; 62 for holding several rollers 1 with the protective container 5.

### Reference Number List

L1 first bearing point's for 1st roller (fixing/heating roller) in the fixing unit

L2 second bearing point/s for 1st roller (fixing/heating roller) in the fixing unit

L3 first bearing point/s for 2nd roller (pressure roller) in the fixing unit

L4 second bearing point/s for 2nd roller (pressure roller) in the fixing unit

F fixing unit

H heating lamp of 1st roller

S recording medium/sheet or strip (paper, film, etc.)

T1 first carrying handle/s of carrying means of the 1st roller

T2 second carrying handle/s of carrying means of the 1st roller

X1 center axis of 1st roller

X2 center axis of 2nd roller

Y1 center axis of the bearing point for the 1st roller

Y2 center axis of the bearing point for the 2nd roller

Z swiveling axis of the top and bottom chassis parts of the fixing unit

1 first/top roller (fixing/heating roller) of the fixing unit

2 second/bottom roller (fixing/heating roller) of the fixing unit

3 means for releasing (locking/unlocking) the rollers in the bearing points

4 means for radially separating (pressing together) the rollers in the fixing unit

5 protective container/handling container for slipping onto the rollers

6 transport container for the roller/s with protective container

10 means on carrying handle/s of the 1st roller for axial/radial centering/guiding of the 1st roller in the bearing points of the fixing unit

11 means on carrying handle/s of the 1st roller for axial/radial centering/guiding of the protective container

30 unlocking/locking lever of the release means on the bearing points

40 actuating lever of the separating means/swiveling means for the rollers

51 inside cavity of the protective container

52 recess/es in the side wall/s of the protective container

53 side wall/s of the protective container

61 securing means for the protective container in the transport container

62 securing means for the rollers in the transport container

63 handle/s on the transport container

1. Device for manual replacement and transport of the roller (1) of a copying machine or an electrophotographic printer, the roller being equipped with carrying means, wherein there is a protective container (5) which can be slipped over a roller (1) which has been released in the machine and its carrying means (T1; T2); and the roller (1) together with the protective container (5) can be removed from the copying machine or printer by its carrying means (T1; T2) which project out of the protective container and can be inserted into it.

2. Device as claimed in claim 1, wherein the protective container (5) has an essentially U-shaped cross sectional profile with an inside cavity (5) for holding the roller (1), which cavity has a diameter which is larger than one outside diameter of the roller, such that in the protective container which has been slipped onto the carrying means of the roller there is no contact between the protective container and the roller.

3. Device as claimed in claim 1, wherein the protective container (5) has recesses (52) in its container wall (53) for holding the carrying means (T1; T2) of the roller, which has an inside width which compared to the assigned outside diameter of the carrying means is predetermined such that the protective container with its recesses is located on the carrying means by clamping.

4. Replaceable roller for a copying machine or an electrophotographic printer, wherein the roller (1), which has on its two axial ends one carrying handle (T1; T2) each as the carrying means, by which the roller can be guided into essentially slotted openings which run radially from the outside periphery to the center axis (Y1) of the bearing points and which are located on the bearing points (L1; L2) of the machine, can be radially inserted into the bearing points and can be removed from them.

5. Roller as claimed in claim 4, wherein the carrying handles (T1; T2) are arranged centered to the axial center axis (X1) on the ends of the roller (1); and the carrying handles of the roller project axially beyond the bearing points (L1; L2) of the machine.

6. Roller as claimed in claim 5, wherein the two carrying handles (T; T2) of the roller (1) have means (10) for axial and radial centering, guiding and holding of the roller in its bearing points (L1; L2) in the machine; the two carrying handles of the roller (1) have means (11) for axial and radial centering, guiding and holding of a protective container (5) on the roller; and the handles (T1; T2) are made in the form of essentially square, round or oval handles, eyes or knobs.

7. Roller as claimed in claim 6, wherein the means (10; 11) for axial and radial centering and guiding of the roller (1) in the bearing points (L1; L2) of the machine and in the recesses (52) of the protective container (5) combined and made integral are located on the carrying handles.

8. Copying machine or electrophotographic printer with a replaceable roller as claimed in one of claims 4 to 7.

9. Device for manual replacement and transport for a roller as claimed in claim 7, wherein the protective container (5) on its two axially located side walls (53) has essentially slotted recesses (52) for holding the center/guiding means (11) of the carrying handles (T1; T2), which means are located on the axial ends of the roller (1); and wherein the inside width of the recesses (52) is matched relative to the assigned outside diameters of the center/guiding means (11) such that the protective container (5) with its side walls (53) are clamped thereon.

10. Device as claimed in claim 9, wherein the slotted recesses (52) for the means (11) on the side walls (53) of the protective container (5) are arranged centered to the axial center axis of the inside cavity of the U-shaped protective container; and the recesses and the inside cavity have identical radial alignments for slipping the protective container onto the roller (1) and for removing it therefrom.

11. Transport container for a replaceable roller, wherein the roller (1) can be manually inserted and removed, and wherein in the transport container there are means (61; 62) for securing the roller.

12. Transport container for a replaceable roller, wherein the protective container (5) which is provided with the roller (1) can be manually inserted and removed, in the transport container there being means (61; 62) for securing the protective container and the roller.

13. Transport container as claimed in claim 12, wherein the means (62) for securing the roller (1) engage the carrying handles (T1; T2) and act against the means (61) for securing the protective container (5); and the means (61; 62) for securing the roller and the protective container are made spring-elastic,

14. Transport container as claimed in claim 12 or 13, wherein it has several securing means (61; 62) for holding several rollers (1) with the protective container (5); and the transport container has two handles (63).

15. Device as claimed in claim 1, wherein the protective container (5) consists of a spring-elastic, thermally resistant and insulating plastic material.

16. Machine as claimed in claim 8, wherein the rollers (1) are made as fixing, heating, pressure, image transfer or sheet conveyor rollers.
